(19) United States
(12) Patent Application Publication
(10) Pub. No.: US 2025/0068982 A1
(43) Pub. Date: Feb. 27, 2025

(54) METHODS AND SYSTEMS FOR DETERMINING FEATURE IMPORTANCE IN AN ENSEMBLE MODEL

(71) Applicant: Panasonic Intellectual Property Management Co., Ltd., Osaka (JP)

(72) Inventors: Yizhou HUANG, Singapore (SG); Chandra Suwandi WIJAYA, Singapore (SG); Debdeep PAUL, Singapore (SG); Koji MIURA, Osaka (JP)

(21) Appl. No.: 18/236,754

(22) Filed: Aug. 22, 2023

(51) Int. Cl. G06N 20/20

(52) U.S. Cl. CPC G06N 20/20

(57) ABSTRACT

According to an embodiment, a method for determining feature importance in an ensemble model including a plurality of Machine Learning (ML) models is disclosed. The method includes receiving a dataset comprising input features and a forecast result. The method also includes generating a ranking-based feature list based on the input features. Further, the method includes generating a feature importance output based on the ranking-based features lists. Furthermore, the method includes determining a weightage value corresponding to each of the plurality of ML models based on an accuracy value associated with the corresponding machine learning model. The method also includes determining a weightage-based feature importance value corresponding to each input feature corresponding to the feature importance output based on the determined weightage value corresponding to each ML model responsible for the corresponding input feature in the feature importance output.

### FIELD OF THE INVENTION

The present invention generally relates to Machine Learning (ML) models, and more particularly relates to systems and methods for determining feature importance in an ensemble model utilizing multiple ML models to generate a forecast result.

### BACKGROUND

Machine learning (ML) is a subset of Artificial Intelligence (AI) and computer science that focuses on the use of data and algorithms to imitate the way that humans learn, gradually improving the accuracy of output. Though ML has a wide range of applications, one such application is ML forecasting. ML forecasting is a type of demand forecasting that uses ML models to predict future demand for a product or service.

With a rapid increase in new products and/or services, an adaption of ML and big data techniques in demand forecasting has increased significantly. As a result, an explanation from an AI model/ML model becomes extremely important, and feature importance is one of the most popular mechanisms to provide said model explainability. However, conventional ML systems utilize a single ML model that has a model-specific method to determine feature importance. Therefore, for ensemble models where a plurality of ML models is used, determining model explainability is challenging.

Specifically, for systems that utilize the ensemble model including a plurality of ML models from diverse model classes, applying an intrinsic/model-specific method to determine model explainability is extremely complex.

Therefore, there is a need for a solution to address the aforementioned issues and challenges.

### SUMMARY

This summary is provided to introduce a selection of concepts, in a simplified format, that are further described in the detailed description of the invention. This summary is neither intended to identify essential inventive concepts of the invention nor is it intended for determining the scope of the invention.

According to an embodiment of the present disclosure, a method for determining feature importance in an ensemble model including a plurality of machine learning models is disclosed. The method includes receiving a dataset comprising a plurality of input features and an input forecast result. The method also includes generating, by each of the plurality of machine learning models, a ranking-based feature list based on the plurality of input features. Further, the method includes generating a feature importance output based on the ranking-based features lists as determined by the plurality of machine learning models, the feature importance output comprising a list of input features from the plurality of input features along with corresponding score values. Furthermore, the method includes determining a weightage value corresponding to each of the plurality of machine learning models based on an accuracy value associated with the corresponding machine learning model. The method also includes determining a weightage-based feature importance value corresponding to each of the input features in the list of input features corresponding to the feature importance output based on the determined weightage value corresponding to each of the plurality of machine learning models responsible for the corresponding input feature in the feature importance output.

According to an embodiment of the present disclosure, a system for determining feature importance in an ensemble model including a plurality of machine learning models. The system includes a memory and at least one processor communicably coupled with the memory. The at least one processor is configured to receive a dataset comprising a plurality of input features and an input forecast result. The at least one processor is also configured to generate, by each of the plurality of machine learning models, a ranking-based feature list based on the plurality of input features. The at least one processor is further configured to generate a feature importance output based on the ranking-based features lists as determined by the plurality of machine learning models, the feature importance output comprising a list of input features from the plurality of input features along with corresponding score values. Also, the at least one processor is configured to determine a weightage value corresponding to each of the plurality of machine learning models based on an accuracy value associated with the corresponding machine learning model. Furthermore, the at least one processor is configured to determine a weightage-based feature importance value corresponding to each of the input features in the list of input features corresponding to the feature importance output based on the determined weightage value corresponding to each of the plurality of machine learning models responsible for the corresponding input feature in the feature importance output.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 in an environment of a system for determining feature importance in an ensemble model including a plurality of Machine Learning (ML) models, according to an embodiment of the present disclosure;

FIG. 2 illustrates an exemplary block diagram of the system of FIG. 1, according to an embodiment of the present disclosure;

FIG. 3 illustrates an exemplary block diagram of various modules of the system of FIG. 1, according to an embodiment of the present disclosure;

FIG. 4 illustrates an exemplary block diagram of various modules of the system of FIG. 1, according to another embodiment of the present disclosure;

FIG. 5 illustrates an exemplary process flow of determining the feature importance in the ensemble model, according to an embodiment of the present disclosure;

FIG. 6 illustrates a Graphical User Interface (GUI) generated by the system of FIG. 1 to represent the feature importance in the ensemble model, according to an embodiment of the present disclosure; and

FIG. 7 illustrates a flow chart depicting a method for determining the feature importance in the ensemble model, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The present disclosure proposes a model explanation method to output ranking-based and weightage-based feature importance of a forecast result regardless of which Artificial Intelligence (AI) or Machine Learning (ML) model is used. The method assists a user to obtain insights and information on which feature contributes most to the forecast result. The method provides human-friendly model explainability via a Graphic User Interface (GUI) to optionally allow users to select different interpretation techniques and to understand the models used for demand forecasting from both global and local aspects of model interpretation (may also be referred as global model interpretation and local model interpretation, respectively). Specifically, the global model interpretation focuses on the model's overall behavior and characteristics across the entire dataset. The primary goal of the global model interpretation is to gain insights into the model's general patterns. Further, the local model interpretation focuses on model's prediction for individual instance in the dataset. The goal of the local model interpretation is to provide explanations for specific predictions/single data point.

According to one embodiment of the present disclosure, a proposed system and a method are disclosed for determining feature importance in an ensemble model including a plurality of ML models. The proposed solution includes generating a ranking-based list of feature importance and a weightage-based list of feature importance corresponding to the plurality of ML models included in the ensemble model. Thus, the proposed solution allows a user to determine feature importance and understand model explainability corresponding to the ensemble model.

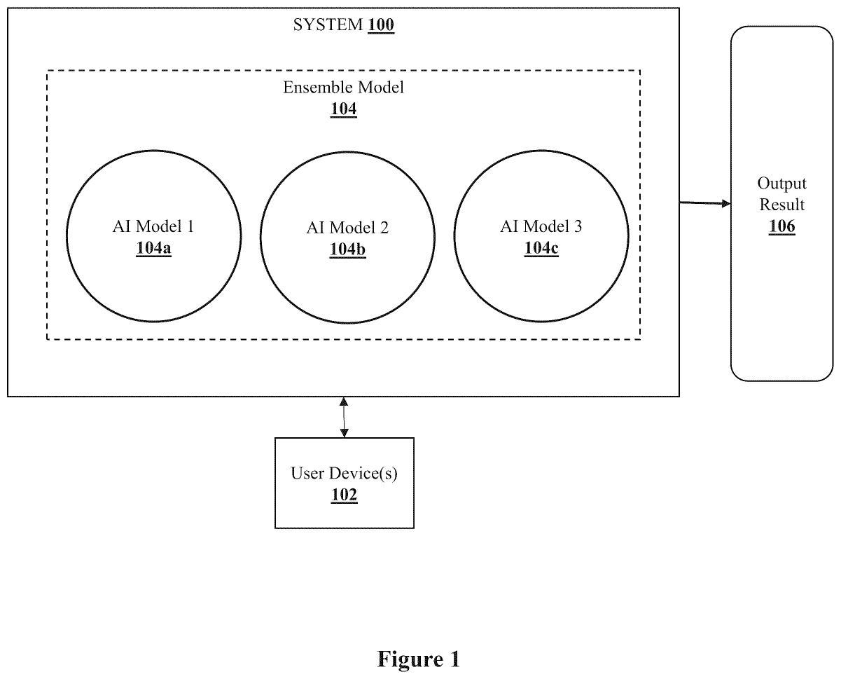

FIG. 1 in an environment of a system 100 for determining feature importance in an ensemble model including a plurality of Machine Learning (ML) models, according to an embodiment of the present disclosure.

The system 100 may correspond to a stand-alone system or a system based in a server/cloud architecture communicably coupled to one or more user devices 102. The system 100 may be configured to implement an ensemble model 104 including a plurality of ML models 104a-104c. In the illustrated embodiment, only three ML models 104a-104c are depicted, however, the ensemble model 104 may include any number of ML models required to effectively perform the required functionality of the system 100, such as demand forecasting. The system 100 may correspond to, but is not limited to, a server, a personal computing device, a user equipment, a laptop, a tablet, a mobile communication device, and so forth.

The system 100 may be disposed in communication with one or more user devices 102. Examples of the user device 102 may include, but are not limited to, a mobile device, a laptop, a tablet, a personal computing device, a handheld device, and so forth.

In an embodiment, the system 100 may be configured to receive input data from the one or more user devices 102. The input data may correspond to information such as, but not limited to, a market index corresponding to a product/service, historical forecast data corresponding to the product/service, and other product/service related information. The system 100 may process the received input data via the ensemble model 104 to generate an output result 106 which is an indication of forecast demand corresponding to the product/service. In an embodiment, the output result 106 may include feature importance results corresponding to various features included in the input data. The feature importance result may correspond to a ranking-based list of the features, and/or a weightage-based list of features. In an embodiment, the system 100 may determine the feature importance result based on the plurality of ML models 104a-104c implemented as a part of the ensemble model 104.

In an embodiment, examples of the ML models 104a-104c may include, a linear regression model, a lasso model, a random forest model, a gradient boost model, and so forth. The various ML models 104a-104c may correspond to any suitable type such as, but not limited to, decision trees, support vector machines, or neural networks, that can perform demand forecasting. Each of the ML models 104a-104c may generate a result based on the input data. The ensemble model 104 may be configured to aggregate the results from the plurality of ML models 104a-104c and generate a final output prediction. The ensemble model 104 reduces an overall error rate of the final output prediction, for example the output result 106.

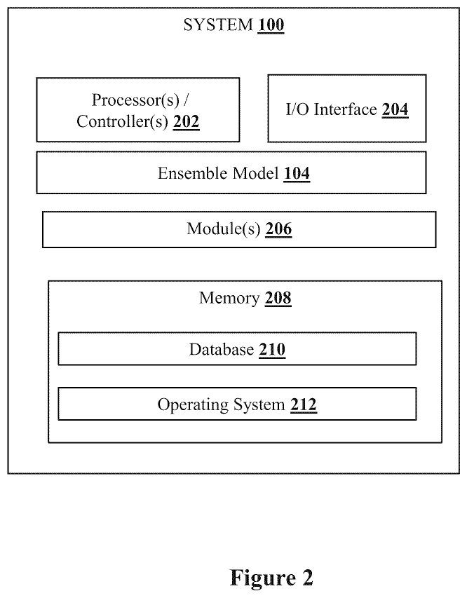

FIG. 2 illustrates an exemplary block diagram of the system 100 of FIG. 1, according to an embodiment of the present disclosure. In an embodiment, the system 100 may be included within the user device 102 (as shown in FIG. 1) and configured to generate predictions based on received input data. In another embodiment, the system 100 may be configured to operate as a standalone device or a system based in a server/cloud architecture communicably coupled to the user device 102. The system 100 may include a processor/controller 202, an Input/Output (I/O) interface 204, one or more modules 206, and a memory 208.

In an exemplary embodiment, the processor/controller 202 may be operatively coupled to each of the I/O interface 204, the modules 206, and the memory 208. In one embodiment, the processor/controller 202 may include at least one data processor for executing processes in Virtual Storage Area Network. In another embodiment, the processor/controller 202 may include specialized processing units such as, integrated system (bus) controllers, memory management control units, floating point units, graphics processing units, digital signal processing units, etc. In one embodiment, the processor/controller 202 may include a Central Processing Unit (CPU), a Graphics Processing Unit (GPU), or both. In another embodiment, the processor/controller 202 may be one or more general processors, digital signal processors, application-specific integrated circuits, field-programmable gate arrays, servers, networks, digital circuits, analog circuits, combinations thereof, or other now-known or later developed devices for analyzing and processing data. The processor/controller 202 may execute a software program, such as code generated manually (i.e., programmed) to perform the desired operation.

The processor/controller 202 may be disposed in communication with one or more input/output (I/O) devices via the I/O interface 204. The I/O interface 204 may employ communication code-division multiple access (CDMA), high-speed packet access (HSPA+), global system for mobile communications (GSM), long-term evolution (LTE), WiMax, or the like, etc.

In an embodiment, when the system 100 is located remotely, the system may use the I/O interface 204 to communicate with one or more I/O devices, specifically, the user device 102 to receive the input data and transmit predictions output along with other relevant information.

In an embodiment, the processor/controller 202 may be disposed in communication with a communication network via a network interface. In an embodiment, the network interface may be the I/O interface 204. The network interface may connect to the communication network to enable connection of the system 100 with the outside environment and/or device/system. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the system 100 may communicate with other devices. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

In an exemplary embodiment, the processor/controller 202 receives a dataset comprising a plurality of input features and an input forecast result. In an embodiment, the input feature may correspond to one or more characteristics corresponding to a product/service for which a demand forecast needs to be generated via the system 100. Examples of such characteristics of the product/service may include, but are not limited to, a location, a sale index, a market index, and the like. Further, the input forecast result may correspond to a prediction performed based on theoretical techniques and/or historical data corresponding to the product/service. In some embodiments, the processor/controller 202 may be configured to pre-process the dataset to identify the plurality of input features and the input forecast result from the received dataset. The pre-processing of the dataset may correspond to, the segregation of the data based at least on a type of data, an amount of data, and so forth.

The processor/controller 202 may generate a ranking-based feature list based on the plurality of input features using each of the plurality of ML models 104a-104c of the ensemble model 104. In an embodiment, the processor/controller 202 may utilize model-specific feature importance methods corresponding to each of the plurality of ML models 104a-104c to determine the ranking-based feature list. For example, the processor/controller 202 may utilize a variable coefficient technique for linear ML models, and an impurity decrement technique for tree-based ML models. Thus, by utilizing model-specific feature importance techniques, the processor/controller 202 reduces the complexity and time required for providing a model explanation of the ensemble model 104.

Thereafter, the processor/controller 202 generates a feature importance output based on the ranking-based features lists as determined by the plurality of ML models 104a-104c. The feature importance output may include a list of input features from the plurality of received input features along with corresponding score values. In an embodiment, the feature importance output may include the list of input features and the corresponding score values based on each of the plurality of ML models 104a-104c. The score value may indicate a number of ML models which have indicated the corresponding input feature as important for the output prediction. For instance, the input features may include a list from A to Z, and the processor/controller 202 may generate the feature importance output as:

Model 1 104a: A, C, D

Model 2 104b: B, D, F, G, H, I

Model 3 104c: C, D, G, P, Q, R

In the illustrated example, the feature importance output may indicate that for ML model 1 104a, the input features A, C, and D are important to generate the desired output forecast result. More specifically, the feature importance output may indicate that for ML models 104a, 104b, 104c, the input feature D is the most important, followed by feature C, and then other features.

In an embodiment, the processor/controller 202 receives a user selection of one or more input features from the list of input features corresponding to the generated feature importance output including the plurality of input features arranged based on the corresponding ranking of each of the input features. The user selection may be based on a user expertise in the relevant field. For instance, if the input features correspond to a product, and the ML model considers a feature of the product as important, the user may provide a user selection indicating whether to consider said feature for generating the output forecast result. Thus, the processor/controller 202 may regenerate the feature importance output based on the user selection of one or more features. In some embodiments, the user may also provide a selection corresponding to the ML models 104a-104c to be used for generating the output forecast result.

In some embodiments, each of the ML models 104a-104c may generate a forecast result based on received input features. The processor/controller 202 may be configured to compare the generated forecast result from each of the plurality of ML models 104a-104c with the input forecast result and assign a model weight corresponding to each of the plurality of ML models 104a-104c based on said comparison. In an embodiment, the processor/controller 202 may determine an accuracy value for each of the plurality of ML models 104a-104c based on the comparison of the generated forecast result with the input forecast result. Further, the processor/controller 202 may compare the accuracy value corresponding to each of the plurality of ML models 104a-104c with a predefined accuracy value to assign the model weight corresponding to each of the plurality of ML models 104a-104c, respectively. In some embodiments, each of the ML models 104a-104c may be configured to generate one or more associated characteristics corresponding to the generated forecast result based on at least one of the input features. In an embodiment, the associated characteristics may indicate an error rate associated with the forecast result. For instance, the ML model may indicate that the forecast result is generated with a 10% error rate, i.e., the actual result may vary from the generated forecast result. Further, the processor/controller 202 may be configured to assign the model weights corresponding to each of the plurality of ML models 104a-104c based on the one or more generated characteristics.

In some embodiments, each of the plurality of ML models 104a-104c may utilize the assigned model weight to generate the corresponding feature importance that may be used by the processor/controller 202 to generate the feature importance output.

The processor/controller 202 may also be configured to determine a weightage value corresponding to each of the plurality of ML models 104a-104c based on an accuracy value associated with the corresponding ML model. In an embodiment, the weightage value corresponding to each of the plurality of ML models 104a-104c may be predefined based at least on a corresponding loss function and/or the accuracy of the model. Further, the processor/controller 202 may be configured to determine a weightage-based feature importance value corresponding to each of the input features in the list of input features corresponding to the feature importance output based on the determined weightage value corresponding to each of the plurality of ML models 104a-104c responsible for the corresponding input feature in the feature importance output. In an embodiment, the processor/controller 202 may be configured to determine a feature weight for each of the input features based on the weightage value of each of the corresponding ML models and a predetermined feature value. The processor/controller 202 may utilize said feature weights corresponding to the input features to determine the weightage-based feature importance value. The processor/controller 202 may determine the weightage-based feature importance value using model-agnostic methods such as, but not limited to, Local Interpretable Model-agnostic Explanations (LIME) and SHapley Additive exPlanations (SHAP). Moreover, the model-agnostic methods may refer to ML interpretability techniques which may be used to explain the prediction of an ML model, irrespective of the type of the ML model. In an embodiment, the predetermined feature value may depend on the model-agnostic methods used by the processor/controller 202. Further, a detailed explanation on the generation of weightage-based feature importance has been provided in the following description.

In some embodiments, the processor/controller 202 may also be configured to generate one or more Graphical User Interfaces (GUIs) to display the generated feature importance output and the determined weightage-based feature importance values corresponding to each of the input features corresponding to the feature importance output. The GUIs may enable a user of the user device 102 to access and interact with information generated by the system 100. The GUIs may be used by the user to provide one or more user inputs such as, but not limited to, user selection of one or more features and/or the ML models.

In an exemplary embodiment, the generated feature importance may correspond to the model explainability of the ensemble model 104. Further, the ensemble model 104 may be implemented in the memory 208 and/or via any other modules/units of the system 100. In some embodiments, the processor/controller 202 may implement the ensemble model 104 using information stored in the memory 208.

In some embodiments, the memory 208 may be communicatively coupled to the at least one processor/controller 202. The memory 208 may be configured to store data, and instructions executable by the at least one processor/controller 202. In one embodiment, the memory 208 may include the ensemble model 104 and/or the one or more ML models 104a-104c, as discussed throughout the disclosure. In another embodiment, the ensemble model 104 may be stored on a cloud network or a server which is to be tested for robustness and accuracy.

In some embodiments, the modules 206 may be included within the memory 208. The one or more modules 206 may include a set of instructions that may be executed by the processor/controller 202 to cause the system 100 to perform any one or more of the methods disclosed herein. The memory 208 may further include a database 210 to store data. In one embodiment, the database 210 may be configured to store the information as required by the one or more modules 206 and processor/controller 202 to perform one or more functions to determine the feature importance corresponding to the ensemble model 104.

The one or more modules 206 may be configured to perform method steps of the present disclosure using the data stored in the database 210, to perform determining of the feature importance corresponding to the ensemble model 104, as discussed throughout this disclosure. In an embodiment, each of the one or more modules 206 may be a hardware unit which may be outside the memory 208.

In one embodiment, the memory 208 may communicate via a bus within the system 100. The memory 208 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 208 may include a cache or random-access memory for the processor/controller 202. In alternative examples, the memory 208 is separate from the processor/controller 202, such as a cache memory of a processor, the system memory, or other memory. The memory 208 may be an external storage device or database for storing data. The memory 208 may be operable to store instructions executable by the processor/controller 202. The functions, acts, or tasks illustrated in the figures or described may be performed by the programmed processor/controller 202 for executing the instructions stored in the memory 208. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like. In some embodiment, the memory 208 may include an operating system 212 to support one or more operations of the system 100 and/or the processor/controller 202.

Further, the present invention contemplates a computer-readable medium that includes instructions or receives and executes instructions responsive to a propagated signal, so that a device connected to a network may communicate voice, video, audio, images, or any other data over a network. Further, the instructions may be transmitted or received over the network via a communication port or interface or using a bus (not shown). The communication port or interface may be a part of the processor/controller 202 or maybe a separate component. The communication port may be created in software or maybe a physical connection in hardware. The communication port may be configured to connect with a network, external media, the display, or any other components in the system 100, or combinations thereof. The connection with the network may be a physical connection, such as a wired Ethernet connection, or may be established wirelessly. Likewise, the additional connections with other components of the system 100 may be physical or may be established wirelessly. The network may alternatively be directly connected to the bus.

For the sake of brevity, the architecture and standard operations of the memory 208, the database 210, the processor/controller 202, and the I/O interface 204 are not discussed in detail.

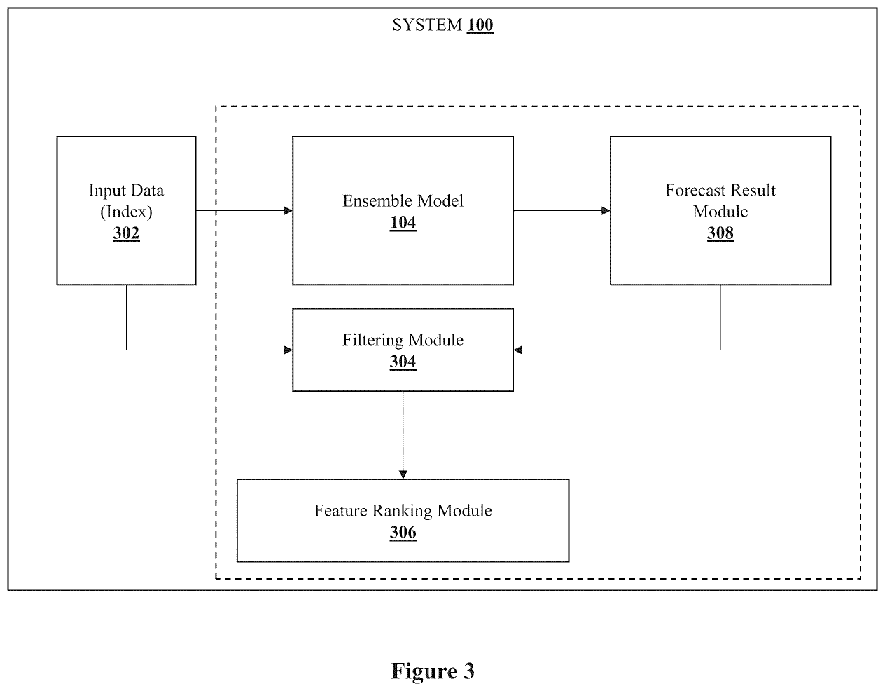

FIG. 3 illustrates an exemplary block diagram of various modules of the system 100, according to an embodiment of the present disclosure. Specifically, FIG. 3 illustrates input data 302, the ensemble model 104, a filtering module 304, a feature ranking module 306, and the forecast result module 308. The ensemble model 104, the filtering module 304, the feature ranking module 306, and the forecast result module 308 may be part of the modules 206, as shown in FIG. 2.

The input data 302 may correspond to the input features and the input forecast result, as explained above. The ensemble model 104 may be configured to receive the input data 302 and generate a forecast result using the plurality of ML models 104a-104c (as shown in FIG. 1) and the forecast result module 308. Each of the plurality of ML models 104a-104c of the ensemble model 104 may generate a forecast which may be aggregated as the forecast result by the forecast result module 308. The forecast result module 308 may be configured to share the generated forecast result with the filtering module 304. The filtering module 304 may receive the input data 302 and the generated forecast result. In an embodiment, the input data 302 may also include one or more user inputs corresponding to expected forecast data. For instance, the input data 302 may include an expected forecast result corresponding to the input features. The filtering module 304 may compare said expected forecast data with the generated forecast result to filter the plurality of ML models 104a-104c to determine the accuracy and/or the reliability of each of the corresponding ML models. Furthermore, the filtering module 304 may be configured to filter and/or un-select one or more ML models from the plurality of ML models 104a-104c based on determined parameters such as, but not limited to, the accuracy of the ML model, or the reliability of the ML model. The filtering module 304 may filter ML models having the accuracy and/or the reliability below a predefined threshold. The predefined threshold may be defined by one or more users and/or the system 100. Thus, the filtering module 304 may be configured to select accurate and reliable ML models for generating the forecast output.

For example, a predefined threshold for the accuracy of an ML model may be defined as 80%. Thus, the filtering module 304 may reject and/or remove any ML model having an accuracy less than the 80% threshold. Specifically, if the ensemble model 104 includes 100 ML models and only 40 of the 100 ML models have an accuracy equal to or greater than 80%, the filtering module 304 may utilize said 40 ML models to generate the desired output forecast result.

In an embodiment, the filtering module 304 may filter ML models based on standard deviation of the error corresponding to ML models. In ML, the standard deviation of the errors is a measure of the variability or spread of the errors across the dataset. Specifically, the standard deviation may indicate a deviation of individual predictions from the true values, on an average. A smaller standard deviation indicates that the model is generally more accurate.

For example, the threshold for validation dataset is pre-defined as 0.2. Further, only 40 of the 100 ML models have a standard deviation of error equal to or smaller than 0.2, the filtering module 304 may utilize said 40 ML models to generate the desired output forecast result,

In some embodiments, the filtering module 304 may be configured to assign a model weight corresponding to each of the plurality of machine learning models 104a-104c based on said comparison of the generated forecast result with the input forecast result. Specifically, the filtering module 304 may assign a lower model weight to the ML models having lower accuracy and/or reliability. Further, the filtering module 304 may assign a higher model weight to the ML models having higher accuracy and/or reliability. Further, a value of the model weight may be determined based at least on the error rate and/or the determined accuracy of the corresponding ML model.

Further, the feature ranking module 306 may be configured to generate a ranking-based feature importance for each of the plurality of ML models 104a-104c. In an exemplary embodiment, the feature ranking module 306 may be configured to receive the selection of ML models from the plurality of ML models and utilize the selected ML models for the generation of the ranking-based feature importance. In an embodiment, the feature ranking module 306 may be configured to generate the ranking-based feature importance only for the ML models selected by the filtering module 304, thus reducing the time and complexity of generating the ranking-based feature importance. The feature ranking module 306 may be configured to utilize any suitable technique to generate the ranking bank feature importance corresponding to each of the selected ML models. Further, the user may select the ML models based on the ranking-based feature importance generated by the feature ranking module 306 to generate the weightage-based feature importance value corresponding to input features.

In an exemplary embodiment, each of the ML models 104a-104c may utilize a corresponding model-specific feature importance calculation. For instance, a lasso model may use coefficients corresponding to input features to define the ranking-based feature importance. Further, a random forest and/or Extreme Gradient Boosting (XGB) model may utilize a decision tree and an amount of variance reduction to generate the ranking-based feature importance.

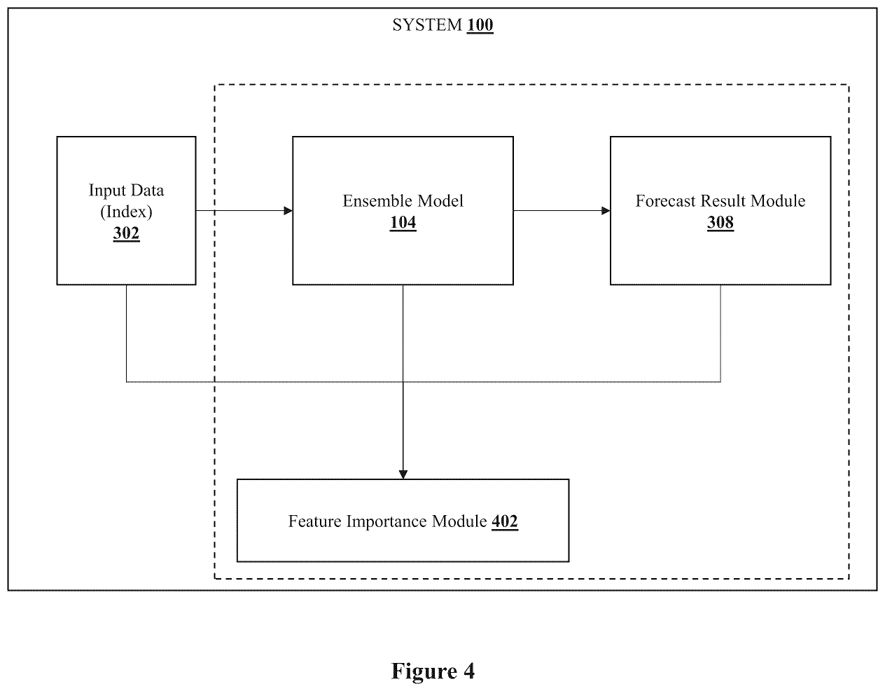

FIG. 4 illustrates an exemplary block diagram of various modules of the system 100, according to another embodiment of the present disclosure. Specifically, FIG. 4 focuses on a feature importance module 402. The feature importance module 402 may also be a part of the modules 206.

The feature importance module 402 may be configured to receive the input data, receive generated forecast results, and retrieve model weights corresponding to each of the plurality of ML models 104a-104c corresponding to the ensemble model 104. The feature importance module 402 may be configured to utilize said received and/or retrieved information to generate weightage-based feature importance for the ensemble model 104. Each of the plurality of ML models 104a-104c corresponding to the ensemble model 104 may utilize the same unified and model agnostic feature importance generation method, such as, but not limited to, a Shapley Value method.

The feature importance module 402 may determine the weightage-based feature importance as follows:
Let's consider, the model weights corresponding to the ML models as follow:
Model 1 with weightage X %,
Model 2 with weightage Y %, and so on.

Further, feature A may be considered an important feature by each of the Model 1 and the Model 2 in the corresponding ranking-based feature importance. Thus, the feature importance module 402 may identify the corresponding weight of feature A, as:

$$Feature A = Shapley {Value}_{Model 1} * X \% + Shapley {Value}_{Model 2} * Y \% + so on .$$

Thus, the feature importance module 402 may be configured to generate the weightage-based feature importance for the ensemble model 104 which is more accurate and reliable as compared to individual accuracy and reliability of the ML models 104a-104c corresponding to the ensemble model 104.

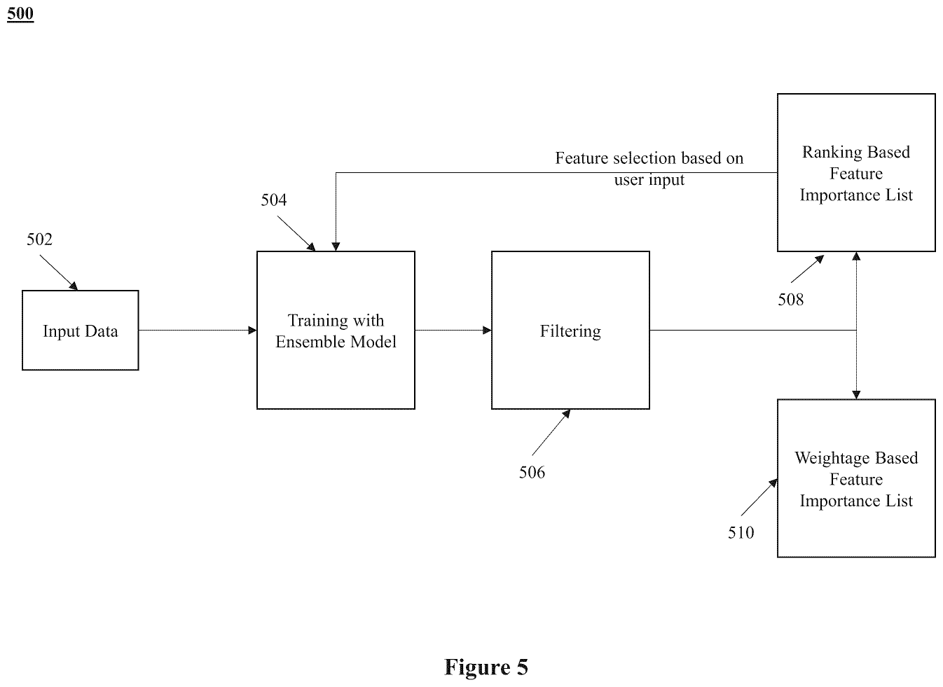

FIG. 5 illustrates an exemplary process flow 500 of determining the feature importance in the ensemble model 104, according to an embodiment of the present disclosure.

At block 502, the system 100 may receive the input data. Further, the system 100 may pre-process the input data to identify the input features and input forecast results from the input data.

At block 504, the system 100 may train the ensemble model 104 to generate the forecast data based on the received input data. The ensemble model 104 may utilize a plurality of ML models such as, but not limited to, linear regression, non-linear regression, and deep neural networks. In some embodiments, a number of the ML models implemented as a part of the ensemble model 104 may be greater than 1000.

At block 506, the system 100 may perform filtering of the plurality of ML models corresponding to the ensemble model 104. The system 100 may receive one or more additional inputs such as, but not limited to, manual forecast results, to select and/or unselect one or more ML models from the plurality of ML models corresponding to the ensemble model 104. In an exemplary embodiment, the system 100 may filter the ML models based at least on the accuracy of the said ML models. The system 100 may determine the accuracy of the ML model based on the manual forecast result and/or the forecast result generated by the corresponding ML model. Specifically, the system 100 may generate a list of ML models from the plurality of ML models based on higher accuracy value. In an embodiment, the list of ML models may include 50-100 accurate ML models from the 1000 ML models. Specifically, at block 506, the system 100 may perform optimization of the input features/models to minimize pre-defined objective functions, such as but not limited to, validation error/variance, and assign optimal weights to the ensembled models. The objective function may also be referred as a loss function or a cost function and may be defined as Mean Square Error (MSE). In general, the ML model aims to adjust the corresponding parameters to minimize the objective function. The smaller the value of the objective function, the better the model's performance.

For each base ML model, the system 100 may calculate the MSE, i.e., the objective function. The objective function for the ensemble model 104 may be defined as a function to minimize an average of the MSEs corresponding to the base AI models 104a-104c. In an embodiment, the objective function encourages the ensembled model 104 to make accurate predictions on unseen data.

At block 508, the system 100 may generate a ranking-based feature importance list corresponding to each of the filtered ML models. In an embodiment, the user may select and/or unselect features based on the generated ranking-based feature importance list. Such user selection may be used to regenerate the ranking-based feature importance list corresponding to each of the filtered ML models. The ranking-based feature importance list is the output of the feature Ranking Module 306 that may presented to the users via GUI. Further, the ranking-based feature importance list may be again fed into the ensemble models 104 to perform further rounds of training. The final output may correspond to forecast results, and associated weightage based feature importance.

At block 510, the system 100 may generate the weightage-based feature importance based at least on the ranking-based feature importance list and the predefined value corresponding to the weightage-based model technique.

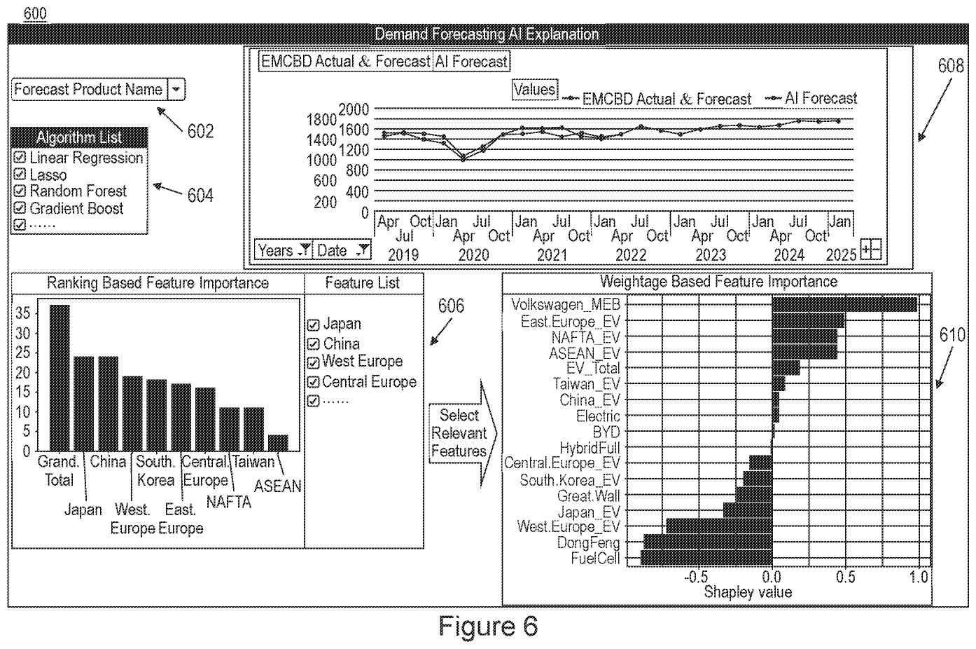

FIG. 6 illustrates a Graphical User Interface (GUI) 600 generated by the system 100 to represent the feature importance in the ensemble model, according to an embodiment of the present disclosure. In an embodiment, the GUI 600 may be generated by the system 100 and represented via a display screen of the user device 102. The GUI 600 may correspond to ML model explainability as generated by the system 100. The GUI 600 may include a first user selection field 602 that may allow a user to select a product/service name for which the system 100 has been used to generate the demand forecast result. The first user selection field may correspond to a drop-down menu that includes a plurality of options corresponding to product/service for user selection. The user may select a desired product/service from the drop-down menu. The GUI 600 may further include a second user selection field 604 that allows a user to select one or more ML models from the plurality of ML models based on the requirement. The GUI 600 may also provide a default selection to the first user selection field 602 and the second user selection field 604.

The GUI 600 may further include a first graphical representation 606 that corresponds to ranking-based feature importance. Specifically, the first graphical representation 606 may represent various input features assigned based on the corresponding ranking as determined by the plurality of ML models of the system 100. The first graphical representation 606 may also include a list of input and/or the displayed input features. The GUI 600 may also allow a user to select/de-select one or more features from the list of input features.

The GUI 600 may also include a second graphical representation 608 that corresponds to a comparison of the generated forecast result and an actual forecast result. The comparison may indicate the accuracy and/or error rate of the ensemble model 104 of the system 100.

The GUI 600 may further represent a third graphical representation 610 which corresponds to the generated weightage-based feature importance for the ensemble model 104. As illustrated, some of the features may be assigned with positive weightage, and some of the features may be assigned with negative weightage. The weights corresponding the features may indicate the impact of features in generating the forecast result.

Thus, the GUI 600 may enable the user to view and interact with the system 100 and/or the information generated by the system 100.

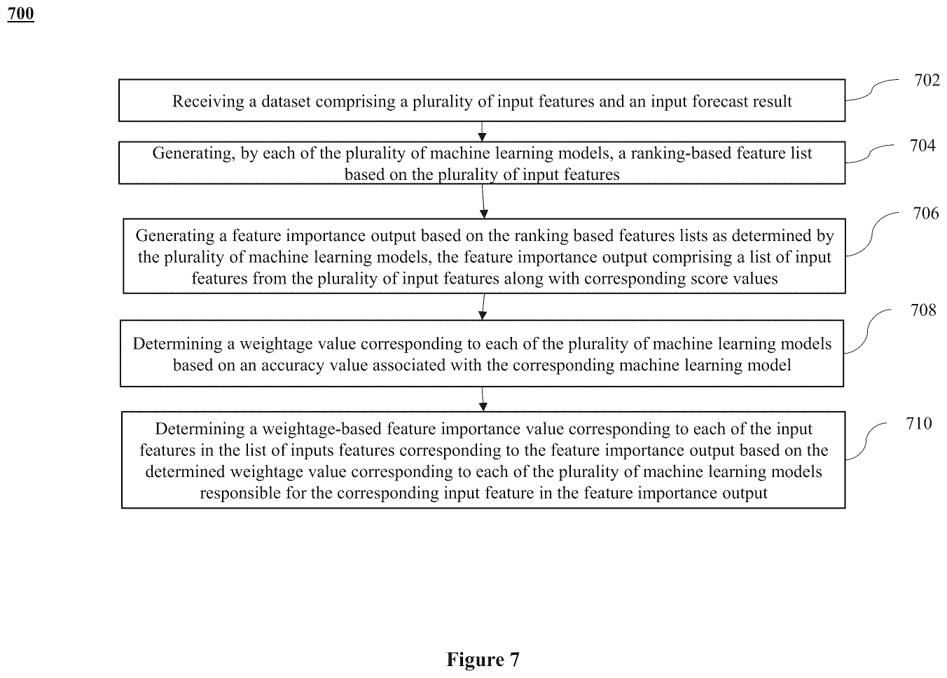

FIG. 7 illustrates a flow chart depicting a method 700 for determining the feature importance in the ensemble model 104, according to an embodiment of the present disclosure. The method 700 may be performed by one or more components of the system 100.

At step 702, the method 700 may include receiving the dataset comprising a plurality of input features and an input forecast result. In an embodiment, the method 700 also includes pre-processing the dataset to identify the plurality of input features and the input forecast result.

At step 704, the method 700 include generating, by each of the plurality of ML models 104a-104c, a ranking-based feature list based on the plurality of input features.

At step 706, the method 700 includes generating a feature importance output based on the ranking-based features lists as determined by the plurality of machine learning models, the feature importance output comprising a list of input features from the plurality of input features along with corresponding score values. In an embodiment, the method 700 includes generating, by each of the plurality of ML models 104a-104c, a forecast result based on the plurality of input features. Further, the method 700 includes comparing, for each of the plurality of ML models 104a-104c, the generated forecast result with the input forecast result. Moreover, the method 700 may include assigning a model weight corresponding to each of the plurality of machine learning models based on said comparison for generating the feature importance output. In some embodiments, the method 700 includes determining, for each of the plurality of ML models 104a-104c, the accuracy value based on the comparison of the generated forecast result with the input forecast result. The method 700 further includes comparing the accuracy value corresponding to each of the plurality of machine learning models with a predefined accuracy value and assigning the model weight corresponding to each of the plurality of ML models 104a-104c based on said comparison of the accuracy value corresponding to each of the plurality of ML models 104a-104c with the predefined accuracy value.

In an alternative embodiment, the method 700 may include generating, by each of the plurality of ML models 104a-104c, a forecast result and one or more associated characteristics based on the plurality of input features, the one or more associated characteristics comprising at least an error rate associated with the forecast result. Further, the method 700 includes assigning the model weight corresponding to each of the plurality of ML models based on the generated forecast result and the one or more associated characteristics for generating the feature importance output.

In some other embodiments, the method 700 may include receiving the user selection of one or more input features from the list of input features corresponding to the generated feature importance output including the plurality of input features arranged based on the corresponding ranking of each of the input features. Further, the method 700 may include regenerating the feature importance output based on the user selection of the one or more features.

At step 708, the method 700 includes determining the weightage value corresponding to each of the plurality of ML models 104a-104c based on the accuracy value associated with the corresponding ML model.

At step 710, the method 700 includes determining the weightage-based feature importance value corresponding to each of the input features in the list of inputs features corresponding to the feature importance output based on the determined weightage value corresponding to each of the plurality of ML models 104a-104c responsible for the corresponding input feature in the feature importance output. In an embodiment, the method 700 may include determining a feature weight, for each of the input features, based on the weightage value of each of the corresponding ML models and a predetermined feature value. The feature weights may be used to determine the weightage-based feature importance value.

In an embodiment, the method 700 may include generating the one or more Graphical User Interfaces (GUIs) 600 to display the generated feature importance output and the determined weightage-based feature importance values corresponding to each of the input features corresponding to the feature importance output.

While the above steps shown in FIG. 7 are described in a particular sequence, the steps may occur in variations to the sequence in accordance with various embodiments of the present disclosure. Further, the details related to various steps of FIG. 7, which are already covered in the description related to FIGS. 1-6 are not discussed again in detail here for the sake of brevity.

To summarize, the present disclosure provides methods and system for determining feature importance in the ensemble model including a plurality of machine learning models with high accuracy and reliability.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A method for determining feature importance in an ensemble model including a plurality of machine learning models, the method comprising:
receiving a dataset comprising a plurality of input features and an input forecast result;
generating, by each of the plurality of machine learning models, a ranking-based feature list based on the plurality of input features;
generating a feature importance output based on the ranking based features lists as determined by the plurality of machine learning models, the feature importance output comprising a list of input features from the plurality of input features along with corresponding score values;
determining a weightage value corresponding to each of the plurality of machine learning models based on an accuracy value associated with the corresponding machine learning model; and
determining a weightage-based feature importance value corresponding to each of the input features in the list of inputs features corresponding to the feature importance output based on the determined weightage value corresponding to each of the plurality of machine learning models responsible for the corresponding input feature in the feature importance output.

2. The method of claim 1, further comprising:
pre-processing the dataset to identify the plurality of input features and the input forecast result.

3. The method of claim 1, further comprising:
generating, by each of the plurality of machine learning models, a forecast result based on the plurality of input features;
comparing, for each of the plurality of machine learning models, the generated forecast result with the input forecast result; and
assigning a model weight corresponding to each of the plurality of machine learning models based on said comparison for generating the feature importance output.

4. The method of claim 3, further comprising;
determining, for each of the plurality of machine learning models, the accuracy value based on the comparison of the generated forecast result with the input forecast result;
comparing the accuracy value corresponding to each of the plurality of machine learning models with a predefined accuracy value; and
assigning the model weight corresponding to each of the plurality of machine learning models based on said comparison of the accuracy value corresponding to each of the plurality of machine learning models with the predefined accuracy value.

5. The method of claim 1, further comprising:
generating, by each of the plurality of machine learning models, a forecast result and one or more associated characteristics based on the plurality of input features, the one or more associated characteristics comprising at least an error rate associated with the forecast result; and
assigning a model weight corresponding to each of the plurality of machine learning models based on the generated forecast result and the one or more associated characteristics for generating the feature importance output.

6. The method of claim 1, further comprising:
receiving a user selection of one or more input features from the list of input features corresponding to the generated feature importance output including the plurality of input features arranged based on the corresponding ranking of each of the input features; and
regenerating the feature importance output based on the user selection of the one or more features.

7. The method of claim 1, wherein determining the weightage-based feature importance value corresponding to each of the input features included in the feature importance output comprises:
determining a feature weight, for each of the input features, based on the weightage value of each of the corresponding machine learning models and a predetermined feature value.

8. The method of claim 1, comprising:
generating one or more Graphical User Interfaces (GUIs) to display the generated feature importance output and the determined weightage-based feature importance values corresponding to each of the input features corresponding to the feature importance output.

9. A system for determining feature importance in an ensemble model including a plurality of machine learning models, the system comprising:
a memory; and
at least one processor communicably coupled with the memory, the at least one processor is configured to:
receive a dataset comprising a plurality of input features and an input forecast result;
generate, by each of the plurality of machine learning models, a ranking-based feature list based on the plurality of input features;
generate a feature importance output based on the ranking based features lists as determined by the plurality of machine learning models, the feature importance output comprising a list of input features from the plurality of input features along with corresponding score values;
determine a weightage value corresponding to each of the plurality of machine learning models based on an accuracy value associated with the corresponding machine learning model; and
determine a weightage-based feature importance value corresponding to each of the input features in the list of inputs features corresponding to the feature importance output based on the determined weightage value corresponding to each of the plurality of machine learning models responsible for the corresponding input feature in the feature importance output.

10. The system of claim 9, wherein the at least one processor is further configured to:
pre-process the dataset to identify the plurality of input features and the input forecast result.

11. The method of claim 9, wherein the at least one processor is further configured to:
generate, by each of the plurality of machine learning models, a forecast result based on the plurality of input features;
compare, for each of the plurality of machine learning models, the generated forecast result with the input forecast result; and
assign a model weight corresponding to each of the plurality of machine learning models based on said comparison for generating the feature importance output.

12. The system of claim 11, wherein the at least one processor is further configured to:
determine, for each of the plurality of machine learning models, the accuracy value based on the comparison of the generated forecast result with the input forecast result;
compare the accuracy value corresponding to each of the plurality of machine learning models with a predefined accuracy value; and
assign the model weight corresponding to each of the plurality of machine learning models based on said comparison of the accuracy value corresponding to each of the plurality of machine learning models with the predefined accuracy value.

13. The system of claim 9, wherein the at least one processor is further configured to:
generate, by each of the plurality of machine learning models, a forecast result and one or more associated characteristics based on the plurality of input features, the one or more associated characteristics comprising at least an error rate associated with the forecast result; and
assign a model weight corresponding to each of the plurality of machine learning models based on the generated forecast result and the one or more associated characteristics for generating the feature importance output.

14. The system of claim 1, wherein the at least one processor is further configured to:
receive a user selection of one or more input features from the list of input features corresponding to the generated feature importance output including the plurality of input features arranged based on the corresponding ranking of each of the input features; and
regenerate the feature importance output based on the user selection of the one or more features.

15. The system of claim 9, wherein to determine the weightage-based feature importance value corresponding to each of the input features included in the feature importance output, the at least one processor is further configured to:
determine a feature weight, for each of the input features, based on the weightage value of each of the corresponding machine learning models and a predetermined feature value.

16. The system of claim 1, wherein the at least one processor is further configured to:
generate one or more Graphical User Interfaces (GUIs) to display the generated feature importance output and the determined weightage-based feature importance values corresponding to each of the input features corresponding to the feature importance output.
